(19) United States
(12) Patent Application Publication
(10) Pub. No.: US 2014/0216458 A1
(43) Pub. Date: Aug. 7, 2014

(54) Air Conditioned and Ambient Fresh Air Supply System for Respirator Users

(71) Applicants: Michael Dean Asbra, Harrison, TN (US); Serena Therese Asbra, Harrison, TN (US)

(72) Inventors: Michael Dean Asbra, Harrison, TN (US); Serena Therese Asbra, Harrison, TN (US)

(21) Appl. No.: 14/255,781

(22) Filed: Apr. 17, 2014

Related U.S. Application Data
(63) Continuation-in-part of application No. 13/303,462, filed on Nov. 23, 2011.

(51) Int. Cl. A62B 9/00; A62B 7/12

(52) U.S. Cl. CPC A62B 9/003; A62B 7/12
USPC 128/204.16

(57) ABSTRACT

A portable air conditioning and ambient fresh air supply system that provides ambient fresh or conditioned air to a user wearing a respirator. The apparatus comprises a cabinet having an upper chamber and a lower chamber. The lower chamber holds a refrigerant air conditioning system and the upper chamber holds a blower that supplies cold air to the surroundings. The user is able to control the temperature of the conditioned air by means of a control panel and the air flow rate by a blower control switch. An air outlet manifold supplies fresh or conditioned air through an air supply line to a respirator mask.

### CROSS-REFERENCE TO RELATED APPLICATIONS

The current application is a continuation-in-part of U.S. patent application Ser. No. 13/303,462, filed Nov. 23, 2011, which claims a priority to the U.S. Provisional Patent application Ser. No. 61/416,601 filed on Nov. 23, 2010.

### FIELD OF THE INVENTION

The present invention relates generally to an apparatus and system for providing conditioned air. More particularly, the present invention produces and supplies ambient air conditioned fresh air or ambient fresh air for users requiring clean air for respirator usage.

### BACKGROUND OF THE INVENTION

In many areas of worldwide occupations, several general skilled trades, construction workers, refinishers, painters, sandblasters (non silica), spray foam insulation applicators, etc., require breathable air in construction zones or areas that contain less than desirable breathable quality air. Depending on the climate and season of the construction zones/areas, keeping the maintenance of proper breathing air quality is important to prevent the fatigue of workers, eliminate exhaustion, cramps, nausea, dizziness and weakness. This system will eliminate the possibility of heat stroke, heat exhaustion and even death. The apparatus and included components increase production, profit margins and assure workers are kept safe and maintain a better attitude towards using respirator fresh air supply systems.

Furthermore, by providing an air conditioned or fresh air supply system that includes respirator protection, skilled trade workers are able to work in an environment with clean, safe, hypoallergenic air. However, many construction zones and areas do not have air conditioning fresh air supply units with respirator protection and workers are forced to work under undesirable conditions. It is therefore an object of the present invention to introduce an apparatus for producing and supplying fresh air conditioned or ambient fresh air for users requiring breathable clean air through a respirator mask. The apparatus and included components provide year round protection and comfort, regardless of climatic regions, ambient temperatures, or the conditions of the work environment

### BRIEF DESCRIPTION OF THE DRAWINGS

FIG. 1 is a perspective exploded view of the present invention with a single line manifold.

FIG. 2 is a top view of the present invention with a double line manifold.

### DETAIL DESCRIPTIONS OF THE INVENTION

All illustrations of the drawings are for the purpose of describing selected versions of the present invention and are not intended to limit the scope of the present invention.

The present invention is a portable air conditioning system that produces and supplies ambient air conditioned or fresh air to trades people that require breathable clean air in working environments where the ambient air is unsuitable for breathing. The present invention utilizes a refrigerant system that contains R-410A, rated as an A1 ASHRAE safety classification, to produce air conditioned or fresh air. The present invention is able take the surrounding ambient air to be conditioned to a specific temperature designated by the operator. The present invention provides strictly positive air flow and does not rely on a supply and return mindset. The present invention is not capable of providing conditioned air for enclosed spaces, rooms or buildings; rather, the present invention provides breathable air to a user in an enclosed space by conditioning ambient air outside the enclosed space and delivering the air to the user through a tube traversing from the main unit positioned outside the enclosed space to the user inside the enclosed space.

The present invention is disclosed in the preferred embodiment as being known in the industry as a type “A” supplied-air respirator, or a hose mask respirator for entry into and escape from atmospheres not immediately dangerous to life or health, which consists of a motor-driven or hand-operated blower that permits the free entrance of air when the blower is not operating, a strong large-diameter hose having a low resistance to airflow, a harness to which the breathing hose is attached and a tight-fitting face piece. The present invention is either portable or can be placed in a permanent position in a work area. The fresh air supply system must be placed so that the air intake is in an environment with clean, breathable quality air. The present invention allows a user to enter work areas with extended air lines and respirator protection to ensure the delivery of clean, breathable conditioned air or fresh air to the respirator user.

The present invention comprises a cabinet 1, a blower 2, a refrigerant air conditioning unit 3, a cabinet cover plate 4, an electrical cord 5, an air outlet manifold 6, and an air supply line 61. The blower 2 and the refrigerant air conditioning unit 3 are positioned within the cabinet and function to supply fresh ambient or conditioned air through the air outlet manifold 6 and thus the air supply line 61 as well. When in use, the air supply line 61 is connected to a respirator in order to allow a user to be supplied with fresh ambient or conditioned air. The respirator should be considered to be an apparatus well known in the art and industry and may comprise any number of applicable types of face or head covering apparatuses suitable for delivering supplied air to a user for breathing, such as, but not limited to, a full face mask respirator, a hood assembly with inner support respirator, an air flow shield respirator, or a bump cap.

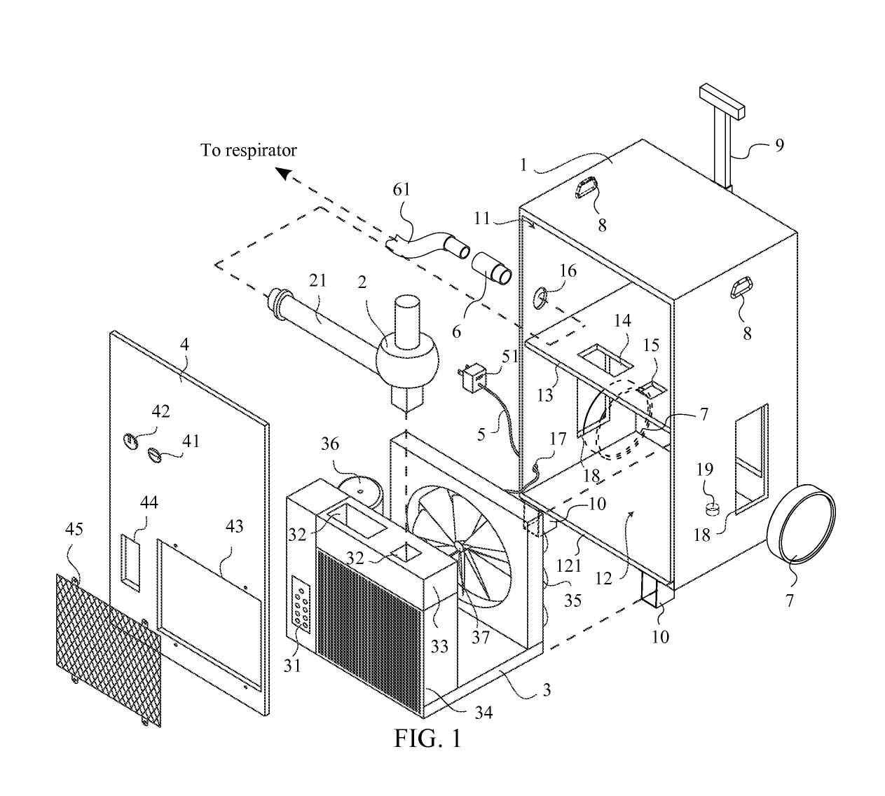

In reference to FIG. 1, the cabinet 1 comprises an upper chamber 11, a lower chamber 12, a partition 13, an air relief hole 14, a blower inlet opening 15, a power cable hole 17, and a cool air outlet hole 16. The cabinet 1 acts as an enclosure and structural support for the blower 2 and the refrigerant air conditioning unit 3. The refrigerant air conditioning unit 3 is able to intake the ambient air, condition the air, and dispense the newly conditioned air into a user's respirator or environment. The blower 2 is able to regulate the rate at which the ambient air is being conditioned. In the preferred embodiment of the present invention, the blower 2 uses a sealed, self contained 97 cubic feet per minute (cfm) fan component to ensure proper air delivery to the user. An example of an improper fan component is an open, squirrel cage design fan component.

The upper chamber 11 and the lower chamber 12 are recessed spaces on the cabinet 1 for the containment of the blower 2 and the refrigerant air conditioning unit 3, respectively. The upper chamber 11 and the lower chamber 12 are separated by the partition 13. The refrigerant air conditioning unit 3 is positioned in the lower chamber 12 of the cabinet 1 and the blower 2 is positioned in the upper chamber 11 of the cabinet 1. The air relief hole 14 and the blower inlet opening 15 are holes that are positioned adjacently to each other and are traversed through the partition 13. As a result, the upper chamber 11 and the lower chamber 12 are connected by the air relief hole 14 and the blower inlet opening 15. The cool air outlet hole 16 is a hole that is traversed through the side of a cabinet 1 leading into the upper chamber 11. In a similar fashion, the power cable is a hole traversed through the cabinet 1 leading into the lower chamber 12. The cabinet 1 further comprises a pair of ventilation holes 18. The ventilation holes 18 are holes positioned and traversing through the sides of the cabinet 1 leading into the lower chamber 12. The pair of ventilation holes 18 allows the internal components of the lower chamber 12 to ventilate during operation to prevent overheating. In an embodiment of the present invention, the ventilation holes 18 may have a protective grille. In the preferred embodiment said protective grille should also be capable of filtering solid particulates out of air flow traversing across the ventilation holes 18. Additionally, in the preferred embodiment the cabinet 1 further comprises a drain plug hole 19 traversing vertically through a floor 121 of the lower chamber 12 of the cabinet 1. The drain plug hole 19 is present in order that water condensation produced by the refrigerant air conditioning unit may be drained out of the cabinet 1.

The refrigerant air conditioning unit 3 further comprises a control panel 31, an air outlet cover 33, an evaporator 34, a condenser 35, and a compressor 36. In the preferred embodiment of the present invention, the refrigerant air conditioning unit 3 comprises a 8000 BTU air conditioning unit, though the refrigerant air conditioning unit 3 is not limited to this specification. The evaporator 34 being connected to the condenser 35 is able to circulate the refrigerant to cool the drawn ambient air. The condenser 35 further comprises a jointly attached fan 37. The control panel 31 is positioned on the refrigerant air conditioning unit 3 adjacent to the evaporator 34. The cool air supply hole 32 is a channel that is positioned over the evaporator 34 and the control panel 31. The cool air supply hole 32 supplies the conditioned air to the blower to be dispensed by the present invention. The cool air supply hole 32 is further enveloped by the condenser outlet cover 33. Connecting the condenser 35 and the evaporator 34 together is the compressor 36. The compressor 36 cycles the refrigerant through the refrigerant air conditioning unit 3 to extract heat from the collected air. With the refrigerant air conditioning unit 3 being positioned in the lower chamber 12, the fan 37 is able to cool the refrigerant in the condenser 35 to release heat from an evaporator hole positioned at the side of the cabinet 1.

The cabinet cover plate 4 is used to enclose the refrigerant air conditioning unit 3 and the blower 2 into the upper chamber 11 and the lower chamber 12. The cabinet cover plate 4 also acts as a front panel for the user to access the controls of the present invention. The cabinet cover plate 4 comprises a blower power switch 41, a blower control switch 42, an evaporator hole 43, a control panel hole 44 and an outer filter 45. The blower power switch 41 and the blower control switch 42 are positioned adjacently to each other on an upper half of the cabinet cover plate 4. The blower power switch 41 and the blower control switch 42 are connected directly the blower 2. The blower power switch 41 provides the user with the ability to allow electrical power to flow to the blower 2. The blower control switch 42 allows the user to regulate the amount of power is relayed to the blower 2 to control the flow rate of air (e.g cubic feet per minute) being conditioned and provided to the users. The evaporator hole 43 is positioned on the lower half of the cabinet cover plate 4. The control panel hole 44 is positioned adjacently to the evaporator hole 43 on the cabinet cover plate 4. When the refrigerant air conditioning unit 3 is positioned into the lower chamber 12 of the cabinet 1 and the cabinet cover plate 4 is fastened onto the cabinet 1 over the upper chamber 11 and the lower chamber 12, the evaporator hole 43 is aligned directly over the evaporator 34 of the refrigerant air conditioning unit 3. Additionally, the control panel hole 44 is aligned directly over the control panel 31 on the refrigerant air conditioning unit 3. The evaporator hole 43 on the cabinet cover plate 4 allows the refrigerant air conditioning unit 3 to draw ambient air from the surrounding environment to be conditioned and delivered. The control panel hole 44 provides the user with access to the control panel 31. As a result, the user is able to manage the temperature of the air conditioned by the present invention. In the preferred embodiment of the present invention, the control panel 31 is a digital control panel 31 that can be programmed to set the specific temperature of the conditioned air. While air is being drawn through the evaporator hole 43, air is being filtered by the outer filter 45. The outer filter 45 is fastened directly to the cabinet cover plate 4 over the evaporator hole 43. With the outer filter 45 being fastened over the evaporator hole 43, all of the air drawn is required to pass through the outer filter 45. This prevents any unwanted particulates from being circulated back into the air. In the preferred embodiment of the present invention, the outer filter 45 is a washable filter that is able to catch dust, pollen, mold, bacteria, and other solid particulates that are in the air. The outer filter 45 should be fully capable of filtering any unwanted solid particulates in the air, and thus must comprise appropriate filter material—a simple mesh or grille arrangement is not adequate for the outer filter as particulates may traverse through large openings in a mesh or grille.

In the preferred embodiment of the present invention, the partition 13 is a completely insulated half inch rigid insulation board. As a result, the upper chamber 11 is separate and insulated from the lower chamber 12. The blower 2 being positioned in the upper chamber 11 further comprises a cool air supply tube 21. The cool air supply tube 21 is an exterior manifold pipe that supplies the regulated air for the present invention. The cool air supply tube 21 is extended from the blower 2 and is fastened to the cool air outlet hole 16. It should be specifically noted that the cool air supply tube 21 is connected to the blower 2 on the downstream side of the blower 2—that is, the air flow path produced by the blower is directional and passes through the blower 2 first, then the cool air supply tube 21 and subsequently through the cool air supply hole 16. The blower 2 is positioned directly over the blower inlet opening 15 which is further aligned with the cool air supply hole 32 of the refrigerant air conditioning unit 3 in the lower chamber 12. The blower 2 moves air from the cool air supply hole 32 to the cool air outlet hole 16 through the cool air supply tube 21. Furthermore, a second cool air supply hole 32 is aligned to the air relief hole 14 on the partition 13.

The air outlet manifold 6 is positioned adjacent to the exterior of the cabinet 1 opposite the upper chamber 11. The air outlet manifold 6 is connected to the cool air outlet hole 16 and the air supply line 61 is connected to the air outlet manifold 6 opposite the cabinet 1. The air outlet manifold 6 and the air supply line 61 are additional components in the air flow path of the present invention which allow air flowing out from the cool air outlet hole 16 to be delivered to a user or users. The air supply line 61 is a flexible tube or hose and may be attached to the air outlet manifold 6 by any appropriate means, such as, but not limited to, hose clamps, a screw thread fitting, similar inner and outer diameters of the breathing tube 61 and the air outlet manifold 6, respectively, or other appropriate means or types of tube or pipe fittings as known in the art. The air supply line 61 may be permanently connected to the air outlet manifold 6 or the air supply line 61 may be able to be removed from the air outlet manifold 6 for transport or storage, but the latter embodiment is preferred. It should be noted that the dimensions of the air outlet manifold 6 and the air supply line 61 are not of particular importance to the functionality of the present invention so long as the dimensions are properly configured with the specifications of the blower 2 and other relevant components of the present invention to be able to deliver a desired air flow rate to the user.

It should be noted that the air supply line 61 has been referred to herein as the entirety of tubing connecting the air outlet manifold 6 and the respirator. However, in practice the air supply line 61 is separated into two portions: a primary air line and a breathing tube. In the preferred embodiment of the present invention the primary air line comprises the majority of tube length between the air outlet manifold and the user. The primary air line preferably comes in a variety of lengths, such as, but not limited to, 100 feet, 150 feet, 200 feet, 250 feet, and 300 feet in length, though the primary air line is not limited to solely the listed lengths. In the preferred embodiment of the present invention, the breathing tube is eight feet in length, but is not limited to said dimension. The purpose of the primary air line is to get the air supply line 61 to the vicinity of the user, and the breathing tube is connected to the primary air line to more particularly provide air to the user. While in use the breathing tube is supported by a waist belt connected around the user's waist, so that the user has improved control for manipulating the breathing tube as necessary while working and so the weight of the breathing tube does not accidentally pull the respirator off the user's face. In the preferred embodiment of the present invention, the primary air line has an inner diameter of 1.25 inches and the breathing tube has an inner diameter of 1 inch. These dimensions are specified so that back pressure is not caused on the blower 2. However, it should be noted that the primary air line and the breathing tube are not limited to said dimensions, and may comprise alternate dimensions as deemed appropriate or necessary for alternate embodiments.

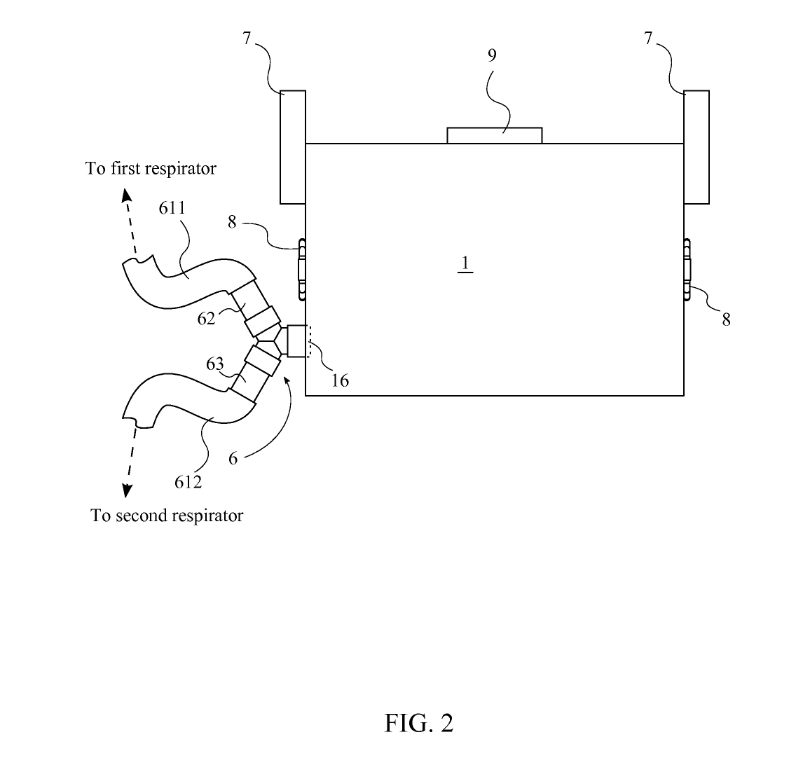

In one embodiment of the present invention, the air outlet manifold 6 comprises a single tube fitting which the air supply line 61 is connected to, as shown in FIG. 1. In an alternate embodiment shown in FIG. 2, the air outlet manifold 6 comprises a first tube fitting 62 and a second tube fitting 63. This alternate embodiment allows two users to be supplied with conditioned air simultaneously from the same unit. A first air supply line 611 is connected to the first tube fitting 62, wherein the first air supply line 611 supplies breathable air from the cool air supply hole 16 to a first respirator apparatus worn by a first user. Similarly, a second air supply line 612 is connected to the second tube fitting 63, wherein the second air supply line 612 supplies breathable air from the cool air supply hole 16 to a second respirator apparatus worn by a second user. Additionally, the present invention is not limited to two users, and it should be noted that alternate embodiments may comprise more than two tube fittings and air supply lines for more than two users.

To power the present invention, the electrical cord 5 is traversed through the power cable hole 17 into the lower chamber 12. The electrical cord 5 is directly connected to the refrigerant air conditioning unit 3 and the blower power switch 41. To protect the present invention from surges, the electrical cord 5 comprises a circuit breaker 51. The circuit breaker 51 is built in-line with the electrical cord 5. In case, a surge is sensed, the circuit breaker 51 automatically cuts power off to the present invention. To reset power to the refrigerant air conditioning unit 3 and the blower 2, the user is able to resent the circuit breaker 51 switch to allow power flow through the electrical cord 5.

The present invention is a portable air conditioning system that is sufficiently small to be easily carried by one man. For such a task, the cabinet 1 can further comprise of a pair of side handles 8 that are connected to the cabinet 1 exterior adjacent to the upper chamber and positioned opposite each other on the cabinet 1. Alternatively or additionally, the present invention comprises an extendable handle 9 connected to the cabinet, positioned vertically and preferably positioned opposite the cabinet cover plate 4 on the cabinet 1. The extendable handle 9 preferably is a T-shaped handle held within a vertical sheath connected to the side of the cabinet 1 that may be slid vertically within the sheath to extend or retract the extendable handle 9. Alternatively or additionally, the cabinet 1 can be pushed or pulled using wheels or casters positioned on the base. Preferably, the present invention comprises a pair of wheels 7 that are connected to the cabinet 1 adjacent to the floor 121 of the cabinet 1 and positioned opposite each other on the cabinet 1. Additionally, the preferred embodiment comprises a pair of legs 10 connected to the bottom of the cabinet 1 opposite the pair of wheels 7 so that the cabinet 1 rests level on both the pair of wheels 7 and the pair of legs 10.

To keep the present invention light and portable, the cabinet 1 can be made from different types of materials including thin steel, aluminum, or any other types of light sturdy metals. In the preferred embodiment of the present invention, the cabinet 1 and the cabinet cover plate 4 is finished with a powder coat application.

Although the invention has been explained in relation to its preferred embodiment, it is to be understood that many other possible modifications and variations can be made without departing from the spirit and scope of the invention as hereinafter claimed.

What is claimed is:

1. An air conditioned and ambient fresh air supply system for respirator users comprises:
a cabinet;
a blower;
a refrigerant air conditioning unit;
a cabinet cover plate;
an electrical cord;
an air outlet manifold;
a air supply line;
the cabinet comprises an upper chamber, a lower chamber, a partition, an air relief hole, a blower inlet opening, a power cable hole, and a cool air outlet hole;
the blower comprises a cool air supply tube;
the refrigerant air conditioning unit comprises a control panel, a cool air supply hole, an condenser outlet covercondenser outlet cover, a condenser, and an evaporator;
the cabinet cover plate comprises a blower power switch, a blower control switch, an evaporator hole, a control panel hole, and an outer filter;
the cool air supply hole being traversed through the cabinet leading into the upper chamber;
the upper chamber and the lower chamber being recessed spaces within the cabinet;
the upper chamber and the lower chamber being separated by the partition;
the air relief hole being traversed through the partition;
the blower inlet opening being traversed through the partition;
the upper chamber and the lower chamber being connected by the air relief hole and the blower inlet opening;
the cool air supply tube being connected between the blower and the cool air outlet hole, wherein the blower moves air from the cool air supply hole to the cool air outlet hole through the cool air supply tube;
the air outlet manifold being positioned adjacent to the cabinet opposite the upper chamber;
the air outlet manifold being connected to the cool air outlet hole; and
the air supply line being connected to the air outlet manifold opposite the cabinet.

2. The air conditioned and ambient fresh air supply system for respirator users as claimed in claim 1 comprises:
the cabinet further comprises a pair of ventilation holes;
the pair of ventilation holes traversing through the cabinet leading into the lower chamber; and
each of the ventilation holes comprises a protective grille.

3. The air conditioned and ambient fresh air supply system for respirator users as claimed in claim 1 comprises:
the refrigerant air conditioning unit being positioned in the lower chamber; and
the blower being positioned in the upper chamber.

4. The air conditioned and ambient fresh air supply system for respirator users as claimed in claim 1 comprises:
the condenser being connected to the evaporator;
the evaporator further comprises a fan;
the fan being attached to the evaporator;
the control panel being positioned on the refrigerant air conditioning unit adjacent to the evaporator;
the cool air supply hole being positioned over the condenser and the control panel; and
the cool air supply hole being enveloped by the condenser outlet cover.

5. The air conditioned and ambient fresh air supply system for respirator users as claimed in claim 1 comprises:
the power cable hole being traversed through the cabinet leading into the lower chamber.

6. The air conditioned and ambient fresh air supply system for respirator users as claimed in claim 1 comprises:
the blower power switch and the blower control switch being positioned adjacently to each other;
the blower power switch and the blower control switch being positioned on an upper half of the cabinet cover plate;
the blower power switch and the blower control switch being connected to the blower;
the evaporator hole being positioned on a lower half of the cabinet cover plate;
the control panel hole being positioned adjacently to the evaporator hole; and
the outer filter being fastened to the cabinet cover plate over the evaporator hole.

7. The air conditioned and ambient fresh air supply system for respirator users as claimed in claim 1 comprises:
the cabinet cover plate being secured to the cabinet over the upper chamber and the lower chamber;
the cool air supply hole being aligned to the blower inlet opening and the air relief hole;
the electrical cord traversed through the power cable hole and being connected to the refrigerant air conditioning unit; and
the cabinet cover plate being fastened to the cabinet over the upper chamber and the lower chamber.

8. The air conditioned and ambient fresh air supply system for respirator users as claimed in claim 1 comprises:
the electrical cord comprises a circuit breaker.

9. The air conditioned and ambient fresh air supply system for respirator users as claimed in claim 1 comprises:
the air outlet manifold comprises a first tube fitting and a second tube fitting;
a first air supply line being connected to the first tube fitting, wherein the first air supply line supplies breathable air to a first respirator apparatus; and
a second air supply line being connected to the second tube fitting, wherein the second air supply line supplies breathable air to a second respirator apparatus.

10. The air conditioned and ambient fresh air supply system for respirator users as claimed in claim 1 comprises:
a respirator mask being connected to the air supply line opposite the air outlet manifold;

11. The air conditioned and ambient fresh air supply system for respirator users as claimed in claim 1 comprises:
the cabinet further comprises a drain plug hole; and
the drain plug hole traversing vertically through the floor of the lower chamber.

12. The air conditioned and ambient fresh air supply system for respirator users as claimed in claim 1 comprises:
a pair of wheels;
the pair of wheels being connected to the cabinet adjacent to a floor of the cabinet; and
the pair of wheels being positioned opposite each other on the cabinet.

13. The air conditioned and ambient fresh air supply system for respirator users as claimed in claim 1 comprises:
a pair of side handles;
the pair of side handles being connected to the cabinet exterior adjacent to the upper chamber; and
the pair of handles being positioned opposite each other on the cabinet.

14. The air conditioned and ambient fresh air supply system for respirator users as claimed in claim 1 comprises:
an extendable handle;
the extendable handle being connected to the cabinet;
the extendable handle being oriented vertically; and
the extendable handle being positioned opposite the cabinet cover plate on the cabinet.
